(19) United States
(12) Patent Application Publication
(10) Pub. No.: US 2013/0124194 A1
(43) Pub. Date: May 16, 2013

(54) SYSTEMS AND METHODS FOR MANIPULATING DATA USING NATURAL LANGUAGE COMMANDS

(71) Applicant: Inventive, Inc., San Francisco, CA (US)

(72) Inventor: Francois Nadal, St. Mande (FR)

(73) Assignee: Inventive, Inc., San Francisco, CA (US)

(21) Appl. No.: 13/675,922

(22) Filed: Nov. 13, 2012

Related U.S. Application Data
(60) Provisional application No. 61/558,396, filed on Nov. 10, 2011.

(51) Int. Cl. G06F 17/28

(52) U.S. Cl. CPC G06F 17/28
USPC 704/9

(57) ABSTRACT

Systems and methods for manipulating data using natural language commands in accordance with embodiments of the invention are disclosed. In one embodiment, a natural language enterprise system includes a database configured to store a natural language index, where the natural language index maps keywords to actions to data, a natural language application server configured to communicate with the database, wherein the natural language application server is configured to receive a command statement, parse the received command statement to identify at least one keyword in the command statement, query the database using at least one keyword to identify at least one actions to data using the natural language index, locate at least one piece of enterprise data to which at least one action to data may be performed, and initiate at least one action to data that is applied to at least one of the located pieces of enterprise data.

### CROSS-REFERENCE TO RELATED APPLICATIONS

The present invention claims priority to U.S. Provisional Patent Application No. 61/558,396, titled “Systems and Methods for Manipulating Data using Natural Language Commands” to Nadal and filed Nov. 10, 2011, the entirety of which is hereby incorporated by reference.

### FIELD OF THE INVENTION

The present invention relates to user interfaces and more specifically to the use of natural language commands to perform actions with respect to data.

### BACKGROUND

Businesses of all sizes rely upon a variety of enterprise software applications as part of their day-to-day operations. In many instances, a business will utilize a first software package for accounting, a second software package for customer relationship management, and another software package for document management. Each of these applications is capable of performing a specific set of actions with respect to the data that is accessible to the application. In the context of enterprise software an action can be thought of as any process performed by the application that involves data. An action can be as simple as retrieving and displaying a single record from within a database or more complex such as generating a report that involves analyzing many records within one or more databases.

### SUMMARY OF THE INVENTION

Systems and methods for manipulating data using natural language commands in accordance with embodiments of the invention are disclosed. In one embodiment, a natural language enterprise system includes a database configured to store a natural language index, where the natural language index maps keywords to actions to data, a natural language application server configured to communicate with the database, wherein the natural language application server is configured to receive a command statement, parse the received command statement to identify at least one keyword in the command statement, query the database using at least one keyword to identify at least one actions to data using the natural language index, locate at least one piece of enterprise data to which at least one action to data may be performed, and initiate at least one action to data that is applied to at least one of the located pieces of enterprise data.

In another embodiment of the invention, at least one located piece of enterprise data is stored using the database.

In an additional embodiment of the invention, at least one located piece of enterprise data is stored using an enterprise data source separate from the natural language enterprise system.

In yet another additional embodiment of the invention, the natural language application server initiates at least one action to data that is applied to at least one of the located pieces of enterprise data by providing a command to initiate at least one action to data to the enterprise data source.

In still another additional embodiment of the invention, at least one piece of enterprise data is identified in the command statement.

In yet still another additional embodiment of the invention, the natural language application server is further configured to generate a user interface displaying at least one of the determined actions to data and receive a selection of an action to data via the user interface, where the selected action to data is selected from the at least one displayed actions to data.

In yet another embodiment of the invention, the natural language application server is further configured to generate a list of actions to data using the natural language index, where the list of actions to data includes actions to data that are relevant to at least one keyword.

In still another embodiment of the invention, the natural language application server is further configured to determine spelling errors in the received command statement and correct the spelling errors.

In yet still another embodiment of the invention, the natural language application server is further configured to determine if a spelling error is a neologism and ignore the spelling error when it is a neologism.

In yet another additional embodiment of the invention, the natural language application server is further configured to identify the language used in the command statement.

In still another additional embodiment of the invention, the natural language application server is further configured to identify the at least one keyword using important words in the command statement, where important words are selected from the group consisting of nouns in the command statement and verbs in the command statement.

In yet still another additional embodiment of the invention, the natural language enterprise system further includes an indexing server configured to communicate with the natural language application server, wherein the indexing server is configured to receive at least one piece of data from at least one enterprise data source and generate a natural language index using the at least one piece of data.

In yet another embodiment of the invention, the indexing server is further configured to generate a relationship tree using the at least one piece of data and build a vocabulary, wherein the generated natural language index indexes the generated relationship tree.

In yet still another embodiment of the invention, the indexing server is further configured to build the vocabulary using the at least one piece of data and a vocabulary source selected from the group consisting of a dictionary and a thesaurus.

Still another embodiment of the invention includes determining natural language commands including receiving a command statement using a natural language enterprise system, parsing the received command statement to identify at least one keyword in the command statement using the natural language enterprise system, identifying at least one actions to data using a natural language index and the natural language enterprise system, where the natural language index maps keywords to actions to data, locating at least one piece of enterprise data to which at least one action to data may be performed using the natural language enterprise system, and initiating at least one action to data that is applied to at least one of the located pieces of enterprise data using the natural language enterprise system.

In yet another additional embodiment of the invention, at least one located piece of enterprise data is stored using the natural language enterprise system.

In still another additional embodiment of the invention, at least one located piece of enterprise data is stored using an enterprise data source separate from the natural language enterprise system.

In yet still another additional embodiment of the invention, determining natural language commands further includes initiating at least one action to data that is applied to at least one of the located pieces of enterprise data by providing a command using the natural language enterprise system to initiate at least one action to data using the enterprise data source.

In yet another embodiment of the invention, at least one piece of enterprise data is identified in the command statement.

In still another embodiment of the invention, determining natural language commands further includes generating a user interface displaying at least one of the determined actions to data using the natural language enterprise system and receiving a selection of an action to data via the user interface using the natural language enterprise system, where the selected action to data is selected from the at least one displayed actions to data.

In yet still another embodiment of the invention, determining natural language commands further includes generating a list of actions to data using the natural language index and the natural language enterprise system, where the list of actions to data includes actions to data that are relevant to at least one keyword.

In yet another additional embodiment of the invention, determining natural language commands further includes determining spelling errors in the received command statement using the natural language enterprise system and correcting the spelling errors using the natural language enterprise system.

In still another additional embodiment of the invention, determining natural language commands further includes determining if a spelling error is a neologism using the natural language enterprise system and ignoring the spelling error when it is a neologism using the natural language enterprise system.

In yet still another additional embodiment of the invention, determining natural language commands further includes identifying the language used in the command statement using the natural language enterprise system.

In yet another embodiment of the invention, determining natural language commands further includes identifying the at least one keyword using important words in the command statement using the natural language enterprise system, where important words are selected from the group consisting of nouns in the command statement and verbs in the command statement.

In still another embodiment of the invention, determining natural language commands further includes receiving at least one piece of data from at least one enterprise data source using the natural language enterprise system and generating a natural language index using the at least one piece of data and the natural language enterprise system.

In yet still another embodiment of the invention, determining natural language commands further includes generating a relationship tree using the at least one piece of data and the natural language enterprise system, where the generated natural language index indexes the generated relationship tree, and building a vocabulary using the natural language enterprise system.

In yet another additional embodiment of the invention, determining natural language commands further includes building the vocabulary using the natural language enterprise system, the at least one piece of data, and a vocabulary source selected from the group consisting of a dictionary and a thesaurus.

Yet another embodiment of the invention includes a natural language enterprise system including a database configured to store a natural language index, where the natural language index maps keywords to actions to data, a natural language application server configured to communicate with the database, a natural language indexing server configured to communicate with the database, and a natural language client device configured to communicate with the natural language application server, wherein the natural language indexing server is configured to receive at least one piece of data from at least one enterprise data source, generate a relationship tree using the at least one piece of data, build a vocabulary, and generate a natural language index using the at least one piece of data, where the generated natural language index indexes the generated relationship tree, wherein the natural language application server is configured to receive a command statement from the natural language client device, parse the received command statement to identify at least one keyword in the command statement, query the database using at least one keyword to identify at least one actions to data using the natural language index, transmit at least one of the identified keywords to the natural language client device, receive at least one action to data from the client device, locate at least one piece of enterprise data to which at least one of the received actions to data may be performed, and initiate at least one of the received action to data that is applied to at least one of the located pieces of enterprise data, and wherein the natural language client device is configured to generate a user interface to receive a command statement, transmit the received command statement to the natural language application server, receive at least one determined actions to data, generate a user interface displaying at least one determined action to data, receive a selection of an action to data via the user interface, where the selected action to data is selected from the at least one displayed actions to data, and transmit the selected actions to data to the natural language enterprise system.

### BRIEF DESCRIPTION OF THE DRAWINGS

FIG. 1 conceptually illustrates a system implementing a natural language enterprise web application in accordance with an embodiment of the invention.

FIG. 2 is a flow chart illustrating a process for performing an action with respect to specific data in response to a natural language command in accordance with an embodiment of the invention.

FIGS. 3A-3C are wireframes that conceptually illustrate completion of an action in response to a natural language command in accordance with an embodiment of the invention.

FIG. 4 is a flow chart illustrating a process for creating an index of actions that can be performed with respect to data accessible to a specific organization, user, or class of user in accordance with an embodiment of the invention.

FIG. 5 is a flow chart illustrating process for identifying keywords within a natural language command in accordance with an embodiment of the invention.

### DETAILED DESCRIPTION

Turning now to the drawings, systems and methods for utilizing natural language commands to perform actions with respect to data in accordance with embodiments of the invention are disclosed. Most enterprise software applications employ highly customized user interfaces that employ semantics that are often specific to the application and non-intuitive to a user unfamiliar with the application. Furthermore, many enterprise software applications demand specialized training to use and/or deploy. In many enterprise systems, a custom user interface is constructed to enable the use of the enterprise system within a specific organization. Contrary to the majority of enterprise software applications, natural language enterprise applications in accordance with a variety of embodiments of the invention are configured to provide an intuitive interface for interacting with the natural language enterprise system.

In many embodiments, a natural language enterprise application provides a user interface enabling a user to provide commands using natural language. In several embodiments, the user interface enables provision of natural language commands via text. In a number of embodiments, the user interface includes speech recognition capabilities and the natural language enterprise application is configured to receive spoken natural language commands. In response to the natural language commands, the natural language enterprise application initiates at least one action with respect to data accessible to a specific user. In a number of embodiments, the action initiated by the natural language enterprise application need not be performed by the web natural language enterprise application, but can involve a request to a web service or separate web application.

The actions with respect to accessible data that can be performed by natural language enterprise applications in accordance with embodiments of the invention are generally defined by the requirements of a specific application and/or business or organization. In a number of embodiments, the natural language enterprise application can access the types of data that are typically generated by a variety of enterprise data sources including, but not limited to, project management, accounting, sales, customer relationship management (CRM), inventory, supply chain, banking, document management, email, business intelligence and/or collaboration systems. In other embodiments, any additional data appropriate to a specific natural language enterprise application can be accessed. In many embodiments, the data is stored within a database maintained by the natural language enterprise application. In several embodiments, some or all of the data that is accessible to the natural language enterprise application is located within databases maintained by other applications. As is discussed further below, the natural language enterprise application can directly perform actions with respect to data that it maintains and/or initiate actions with respect to data maintained by other applications in response to natural language commands. In many embodiments, the actions are simple actions such as retrieval of a record from a database. In several embodiments, more complex actions can be performed that involve the creation of a template or form that is prepopulated with data. In a number of embodiments, the action can involve retrieval and addition or modification of data. As can readily be appreciated, the actions that can be performed are only limited by the capabilities of a specific natural language enterprise application.

In many embodiments, the natural language enterprise application continuously crawls enterprise data sources that are accessible to a specific organization, user, and/or class of user to build a description of the accessible data and the actions that can be performed on the data by the natural language enterprise application and/or other applications. In several embodiments, accessible data and the actions that can be performed with respect to the accessible data are represented as a relationship tree. In other embodiments, any of a variety of data structures can be utilized to capture the relationships that exist between the accessible data and the actions that can be performed with respect to the data.

Natural language enterprise applications in accordance with many embodiments of the invention index a description of accessible data and the actions that can be performed on the accessible data using a vocabulary of keywords. The keyword vocabulary can be generated in any of variety of ways including through the use of dictionaries and thesauruses. In many embodiments, data accessible to the natural language enterprise application is used to identify additional keywords including (but not limited to) company names and/or other data that may be a neologism. When the natural language enterprise application receives a natural language command, the natural language enterprise application identifies keywords within the natural language command and provides a list of actions with respect to specific data sorted by importance and/or relevance using the index. In many embodiments, the user selects the desired action and the natural language enterprise application initiates the action. As discussed above, the natural language enterprise application may not directly perform the action. Instead, the natural language enterprise application can request that the action be performed using any technique for inter-application communication including (but not limited to) a web service and/or an application programming interface (API). Natural language enterprise applications and methods for initiating actions with respect to data utilizing natural language commands in accordance with embodiments of the invention are discussed further below.

### System Architectures

Natural language enterprise applications in accordance with embodiments of the invention include an indexing and search engine system that is configured to crawl some or all of the data accessible to a specific organization, user, and/or class of user and build a description of all of the actions that can be performed with respect to the crawled data. The natural language enterprise application can then generate an index that can be utilized to identify actions that can be performed with respect to the accessible data that are relevant to a specific vocabulary of keywords and/or keyword combinations. The vocabulary of keywords is specifically defined based upon a specific application and is designed to encompass all of the possible terms that a user can utilize in providing a command to the natural language enterprise application. The natural language enterprise application can then extract keywords from natural language commands provided by the user via a user interface and can use the extracted keywords to identify actions that can be performed with respect to data accessible to the user that are relevant to the natural language command. In many embodiments, the systems and methods described in U.S. patent application Ser. No. 10/908,870 entitled “Method, System and Interface Enabling a User to Access the Computer Resources of a Computer Processing Device in an Ergonomic and Intuitive Manner” to Nadal can be utilized by the natural language enterprise application to access databases maintained by other applications. The disclosure of U.S. patent application Ser. No. 10/908,870 is incorporated by reference herein in its entirety.

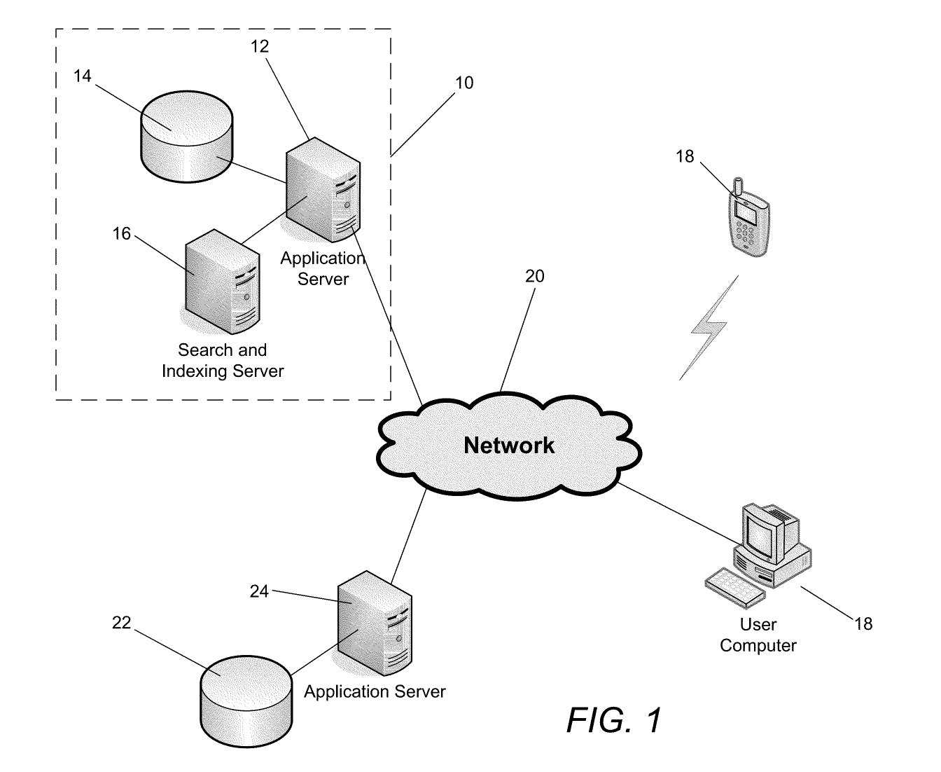

A system for implementing an enterprise web application that can initiate actions with respect to specific data in response to natural language commands in accordance with an embodiment of the invention is illustrated in FIG. 1. In the illustrated embodiment, the enterprise web application 10 is implemented using an application server 12 that is configured to communicate with a database 14 and a search and indexing server 16. The application server generates a user interface and is configured to handle communication with a variety of user devices 18 via a network 20 such as the Internet, a local area network, and/or a wide area network. In the illustrated embodiment, the user devices include a personal computer and a mobile phone. In many embodiments, any of a variety of devices that can communicate with the application server 12 via the network 20 can be utilized.

The application server 12 is configured to perform actions with respect to data stored in the database 14. The data stored in the database typically depends upon the functionality of the enterprise web application 10 that is directly implemented by the application server 12. As is discussed further below, a great deal of the functionality of an enterprise web application in accordance with embodiments of the invention can be implemented via other applications. The types of data that are stored in the database 14 maintained by the application server and in other databases 22 accessible to the enterprise web application, and the actions that can be performed with respect to the accessible data typically depends upon the requirements of a specific application and/or enterprise.

The search and indexing server 16 is configured to build a description of all of the actions that can be performed with respect to the accessible data for each organization, user, and/or class of user that accesses the system. As is discussed further below, the search and indexing server 16 crawls all accessible sources of data to build descriptions of the actions that can be performed by each organization, user, and/or class of user. As discussed above, data can be accessible to a user via applications other than the natural language enterprise application. For example, the enterprise web application 10 may access data within the database 14 maintained by the application server 12 and additional data stored in a database 22 maintained by an application server 24 associated with another application or web service such as (but not limited to) the Google Apps services provided by Google, Inc. of Mountain View, Calif. Irrespective of the location of the data, the search and indexing server 16 is configured to crawl all accessible data for the purposes of generating a description of the actions that a specific organization, user, and/or class of users can perform with respect to the accessible data. In several embodiments, the description of the actions that can be performed with respect to the accessible data built by the search and indexing server 16 is unique to a specific user. In a number of embodiments, the enterprise web application is configured to enable the definition of user access permissions. Therefore, the search and indexing server can be configured to generate separate descriptions of the actions that can be performed with respect to accessible data based for each defined permission level within a specific enterprise. Typically, the manner in which the search and indexing server builds descriptions of actions that can be performed with respect to data is dependent upon the requirements of a specific application. Processes for building descriptions of the actions that can be performed with respect to accessible data in accordance with embodiments of the invention are discussed further below.

In order to interpret natural language commands, the search and indexing server 16 indexes the description of the actions that can be performed with respect to the accessible data against a vocabulary of keywords. In many embodiments, the vocabulary is built using a combination of dictionaries, thesauruses, and terms contained within the data accessible to the enterprise web application. The index itself can be built by hand and/or using a classifier. By parsing natural language commands, the search and indexing server can identify keywords that can be used in combination with the index to identify actions to data that are relevant to the keywords. The term “action to data” is used herein to describe actions that are performed with respect to specific data. An action to data can also include an action that involves the creation of new data (e.g. creating a new contact). A list of relevant actions to data can be provided to the application server 12 for display via a user device 18. The user can confirm a specific command, and the application server can then initiate the requested action to data. In many instances, performing the action involves initiating a dialogue with the user in which additional natural language commands are processed contextually to enable the completion of the action. In a number of embodiments, the search and indexing server observes the selection and can modify the index for a specific user, class of user and/or enterprise based upon the user's selection.

In many embodiments, the search and indexing server repeatedly crawls the data accessible to an organization, user, and/or class of user and updates both the description of the actions that can be performed with respect to the accessible data and the index. The process of updating the description of the actions that can be performed with respect to the accessible data and the index can be collectively referred to as updating the index maintained by the search and indexing server with respect to a specific organization, user, and/or class of user. Depending upon the requirements of a specific application, the search, and indexing server can update its indexes continuously, periodically and/or in response to modifications to the accessible data. In many embodiments, the vocabulary utilized to generate the index can also be continuously updated and the indexes maintained by the search and indexing server updated accordingly.

Although specific systems for implementing enterprise web applications in accordance with embodiments of the invention are discussed above, any of a variety of system architectures that enable users to interact with the system via a user interface and that are configured to crawl and index data accessible to the user can be utilized in accordance with embodiments of the invention including architectures in which the natural language enterprise application is not web based. Initiating actions in response to natural language commands in accordance with embodiments of the invention are discussed further below.

### Initiating Actions With Respect to Data in Response to Natural Language Commands

In operation, natural language enterprise applications in accordance with many embodiments of the invention receive natural language commands via a user interface and perform actions in response to the natural language commands. In a number of embodiments, the command statement can be provided as text. In many embodiments, the command statement can be provided as speech and converted to text using automated speech recognition. The natural language enterprise applications can interpret the natural language command and perform an appropriate action to data.

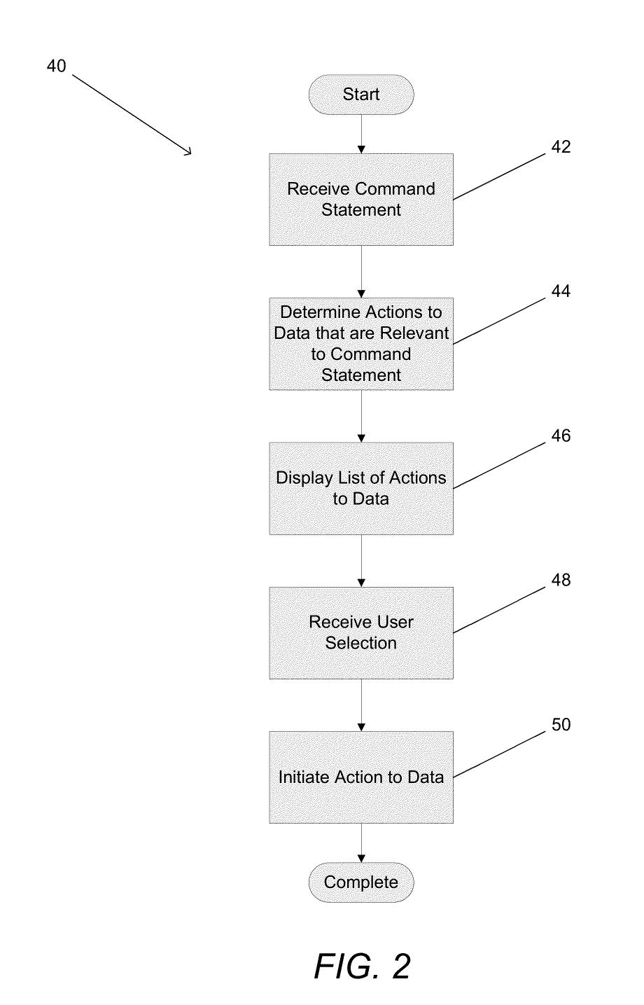

A process for initiating an action with respect to specific data in response to a natural language command in accordance with an embodiment of the invention is illustrated in FIG. 2. The process 40 includes receiving (42) a command statement. The command statement is a natural language statement that includes a command relating to at least one action to be performed with respect to specific data. The specific data can be expressly identified in the command statement (e.g. “update John Smith's email address”) or can be implicit in the command statement (e.g. “what was our profit last month”). When a command statement is received, the actions to data that are relevant to the command statement are determined (44). Processes for determining the actions to data that are relevant to a particular command statement typically involve parsing the command statement to identify at least one keyword and then using the at least one keyword to identify relevant actions to data using an index. Processes for identifying keywords in command statements, generating indexes of actions to data, and identifying actions to data that are relevant to keywords in accordance with embodiments of the invention are discussed further below.

A list of actions to data that are determined to be relevant to a specific command statement can be displayed (46) to a user and the user can select (48) the appropriate action to data, which initiates (50) the performance of the selected action(s) with respect to the specified data. In many embodiments, performance of the action involves additional dialogue with the user to obtain additional parameters and/or resolve ambiguities inherent to the original command statement. In this way, processes in accordance with embodiments of the invention can interact with a user via natural language and elicit the instructions utilized to complete a specific action or sequence of actions with respect to specific data. In many instances, including (but not limited to) report generation and business intelligence analysis, leading a user through a natural language dialogue to obtain necessary instructions enables the user to perform complex tasks using an natural language enterprise application with little or no familiarity with the semantics employed by the natural language enterprise application.

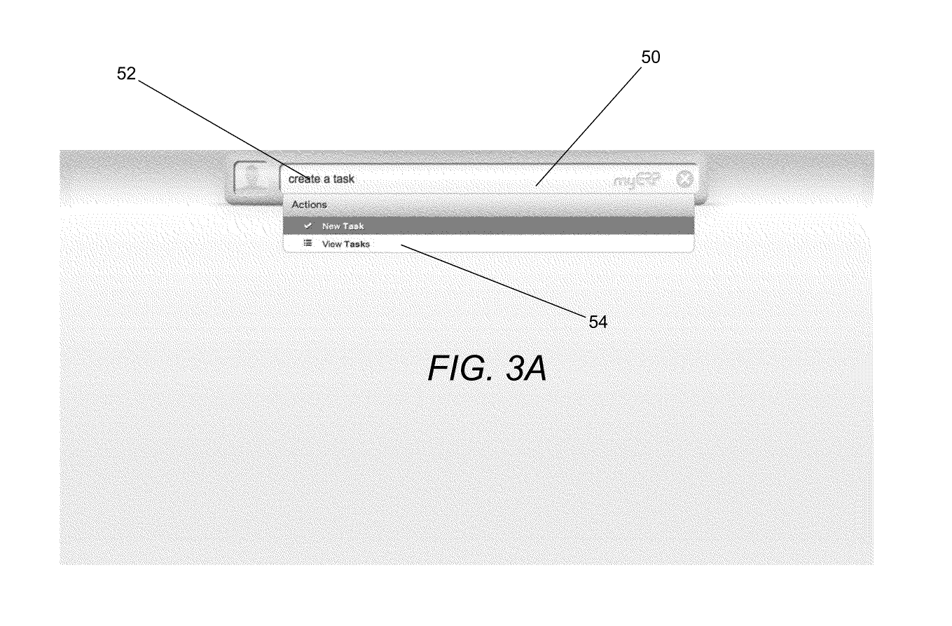

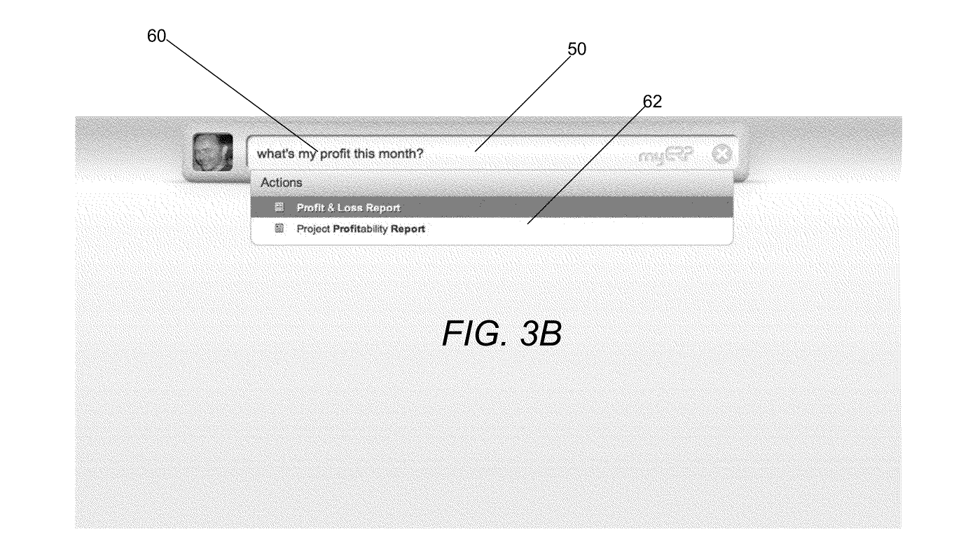

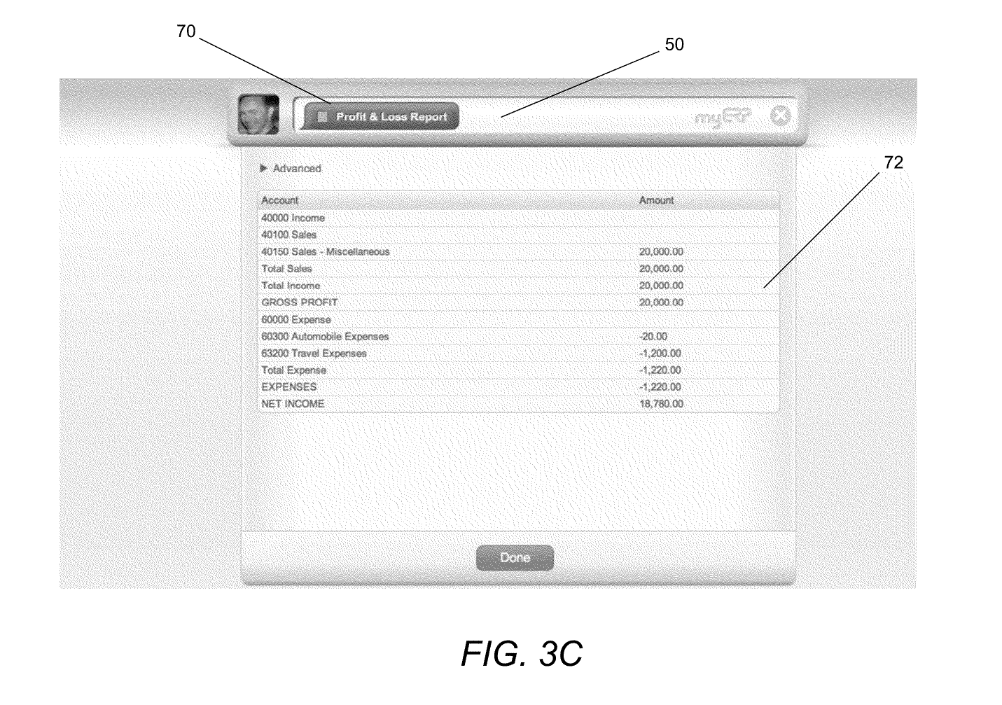

The process outlined above with respect to FIG. 2 is conceptually illustrated using the wireframe screen shots illustrated in FIGS. 3A-3C. The user interface conceptually illustrated in FIG. 3A is a simple text box 50 in which a user can enter a natural language command. Prior to the user entering a natural language command, the user interface displays a prompt 52 directing the user to “create a task” and displays a pull down menu 54 of actions. The actions are to create a new task or to view the tasks that can be performed using the natural language enterprise application.

In the user interface conceptually illustrated in FIG. 3B, the command statement 60 “what is my profit this month?” is entered into the text box 50. In response to the command statement, the natural language enterprise application identifies the actions to data that are most relevant to the natural language command and the identified actions to data are displayed in the pull down list 62. In the illustrated embodiment, the actions to data are “Profit & Loss Report” and “Project Profitability Report.” The user can highlight the correct action to data by selecting the appropriate action to data from the list.

The user interface conceptually illustrated in FIG. 3C illustrates the display of a profit and loss report generated by a natural language enterprise application in response to the user's selection of “Profit & Loss Report” from the list of relevant actions to data. In response to the selection, the action “Profit and Loss Report” is displayed in the task box 50 and the profit and loss report 72 generated by the natural language enterprise application is shown below the text box 50.

Although specific user interfaces generated by a natural language enterprise application in accordance with embodiments of the invention are illustrated in FIGS. 3A-3C, any of a variety of user interfaces can be generated as appropriate to the specific natural language command and technique for command entry. As noted above, a single natural language command may be insufficient to provide the necessary instructions to perform task completion. In which case, the user interface of the natural language enterprise application can engage the user in a dialogue that elicits the necessary instructions to complete the action.

Although a specific processes for performing actions with respect to data in response to natural language commands is illustrated in FIG. 2 and FIGS. 3A-3C, any of a variety of processes can be utilized to interact with a user to obtain natural language commands and to determine the actions to data that are relevant to the natural language commands in accordance with embodiments of the invention. Processes for determining actions to data that are relevant to a natural language command in accordance with embodiments of the invention are discussed further below.

### Determining Relevant Actions to Data

Natural language enterprise applications in accordance with many embodiments of the invention determine the relevance of a command statement containing a natural language command to the various actions that can be performed with respect to data accessible to the natural language enterprise application by creating an index that relates a vocabulary of keywords to the actions to data that can be initiated by the natural language enterprise application. The natural language enterprise application can then identify the keywords contained within a command statement and use the index to identify actions to data that are relevant to the keyword.

### Building an Index of Actions to Data

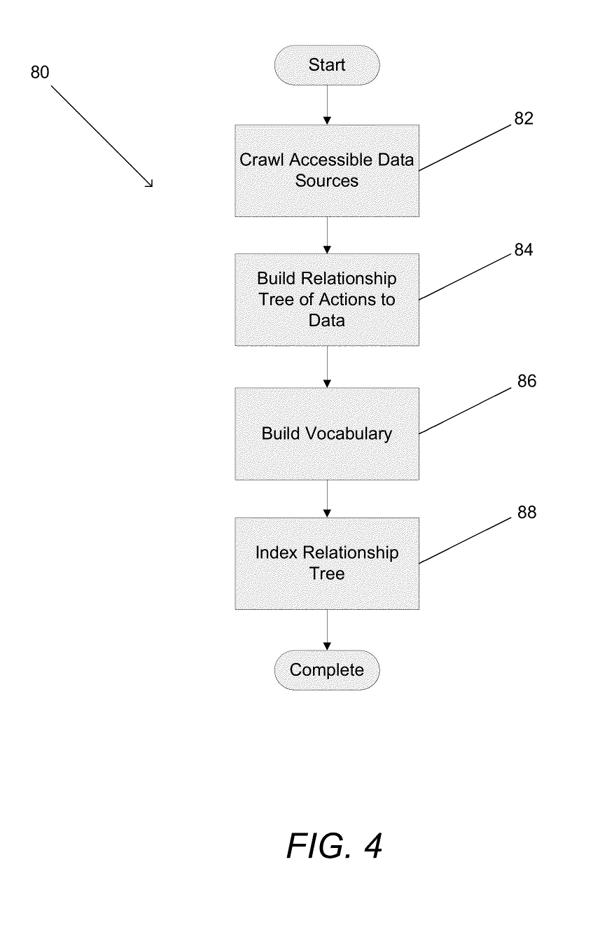

A process for creating an index that relates a vocabulary of keywords to the actions to data that can be initiated by the natural language enterprise application in accordance with embodiments of the invention are illustrated in FIG. 4. The process 80 involves crawling (82) all accessible enterprise data sources to identify all accessible data. A variety of different representations can be utilized to describe the actions that can be performed with respect to data accessible to a specific organization, user, and/or class of user. In the illustrated embodiment, the actions that can be performed with respect to data accessible to a specific organization, user, and/or class of user are represented using a relationship tree.

The process 80 further includes building (84) a relationship tree. A relationship tree is a technique for hierarchically representing relationships between items. In many instances, a relationship tree is a data structure that identifies a root item and the data structure describes the manner in which other items depend or are related. Relationship trees can express positive relationships and/or negative relationships between items. In the context of describing actions that can be performed with respect to data, a relationship tree can be utilized to describe specific actions and the relationship that the actions have to specific data. More important actions are typically promoted to higher levels within the hierarchy defined by the relationship tree. Furthermore, the relationship tree can include nodes corresponding to a sequence of actions to data, which can be referred to as an action family or a macro.

As is discussed further below, natural language commands can be utilized to index (88) to specific points in the relationship tree. Assuming that the indexed node describes an action and identifies the related data used to complete the action, a natural language enterprise application in accordance with embodiments of the invention can initiate the action. Where the indexed node describes an action without identifying the specific information on which to perform the action, a natural language enterprise application in accordance with embodiments of the invention can use the relationship tree to initiate a dialogue to obtain the information needed to complete the action. Examples of circumstances in which a dialogue may be utilized to complete an action include (but are not limited to) instances where the natural language command is incomplete (e.g. “update contact phone number” without specifying a contact) or instances where the natural language command is ambiguous (e.g. “update Jim's contact phone number”, where two Jims are listed in the user's contacts). Although the use of relationship trees for the purpose of describing the actions that can be performed with respect to data accessible to a specific organization, user, and/or user class is discussed above, any of a variety of data structures can be utilized to capture relationships between actions that can be initiated by a natural language enterprise application and accessible data in accordance with embodiments of the invention.

A description of the actions that can be performed with respect to accessible data can be indexed using a vocabulary of keywords. Therefore, the process 80 illustrated in FIG. 4 includes building (86) a vocabulary of keywords. The vocabulary can be generated in any of a variety of different ways including using publicly available vocabularies, dictionaries, thesauruses, and/or terms utilized within the accessible data. In many embodiments, a vocabulary of relevant terms is built based upon the semantics utilized by the natural language enterprise application. The terminology employed by the natural language enterprise application is expanded to create a relevant set of keywords utilizing dictionaries and thesauruses to identify synonyms. In addition, accessible data can be crawled to identify additional relevant terms. In this way, a relatively small number of actions can be utilized to build a large list of possible requests. Although specific processes for building a vocabulary are described above, any process that generates a suitable vocabulary can be utilized in accordance with embodiments of the invention.

Once a vocabulary appropriate to a specific application is obtained, the vocabulary can be utilized to index the relationship tree of actions to data by assigning scores to each of the keywords and keyword combinations within the vocabulary with respect to each of the nodes in the relationship tree. In a number of embodiments, scores can be manually assigned based upon domain expertise. In several embodiments, the scores are assigned using a classifier designed to learn the semantic relationships between keywords and keyword combinations and specific actions represented within the relationship tree. In many embodiments, the scores are continuously refined in response to user selections. These refinements can be based upon the selections of all users of the natural language enterprise application, all users within a specific organization, all users within a specific of class of user, and/or a specific user. Once the index is generated, the index can be utilized to match keywords with actions to data represented within the relationship tree. Processes for extracting relevant keywords from natural language commands in accordance with embodiments of the invention are discussed further below.

### Parsing Natural Language Commands

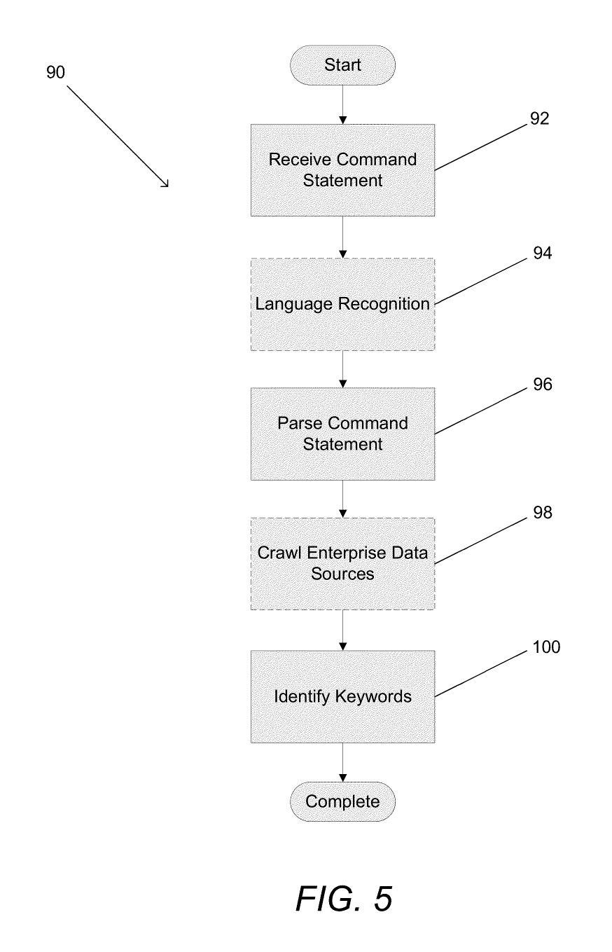

A process for parsing a natural language command to identify keywords in accordance with an embodiment of the invention is illustrated in FIG. 5. The process 90 includes receiving (92) a command statement. In several embodiments, the diversity of the user base of a natural language enterprise application is sufficiently broad that the system accommodates commands in multiple languages. Therefore, language recognition (94) can be performed to identify the language used to formulate the command statement and the subsequent parsing of the command statement can be modified accordingly.

Any of a variety of processes can be utilized in the parsing (96) of the command statement. Parsing typically involves performing a grammatical analysis of a command statement to identify nouns and verbs indicative of actions and objects. In many embodiments, punctuation is removed from the command statement to facilitate parsing. Spell checking can be performed to correct spelling mistakes. However, potential spelling mistakes can also be cross referenced (98) against terms utilized within accessible data to confirm that a spelling mistake is present and not a neologism that is present within the accessible data. The accessible data can also be utilized to provide additional context. The parsing process identifies (100) the important words in the command statement (i.e. nouns and verbs corresponding to actions and objects) and these words are utilized as keywords to search an index of actions to data. In many embodiments, the important words are matched to keywords within a vocabulary using a thesaurus to facilitate the mapping of the natural language command to the keywords of the index of actions to data. Although a specific process for extracting keywords from a command statement is illustrated in FIG. 5, any of a variety of processes that identify keywords from natural language can be utilized as appropriate to the requirements of a specific application in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A natural language enterprise system, comprising:
a database configured to store a natural language index, where the natural language index maps keywords to actions to data;
a natural language application server configured to communicate with the database;
wherein the natural language application server is configured to:
receive a command statement;
parse the received command statement to identify at least one keyword in the command statement;
query the database using at least one keyword to identify at least one actions to data using the natural language index;
locate at least one piece of enterprise data to which at least one action to data may be performed; and
initiate at least one action to data that is applied to at least one of the located pieces of enterprise data.

2. The natural language enterprise system of claim 1, wherein at least one located piece of enterprise data is stored using the database.

3. The natural language enterprise system of claim 1, wherein at least one located piece of enterprise data is stored using an enterprise data source separate from the natural language enterprise system.

4. The natural language enterprise system of claim 3, wherein the natural language application server initiates at least one action to data that is applied to at least one of the located pieces of enterprise data by providing a command to initiate at least one action to data to the enterprise data source.

5. The natural language enterprise system of claim 1, wherein at least one piece of enterprise data is identified in the command statement.

6. The natural language enterprise system of claim 1, wherein the natural language application server is further configured to:
generate a user interface displaying at least one of the determined actions to data; and
receive a selection of an action to data via the user interface, where the selected action to data is selected from the at least one displayed actions to data.

7. The natural language enterprise system of claim 1, wherein the natural language application server is further configured to generate a list of actions to data using the natural language index, where the list of actions to data comprises actions to data that are relevant to at least one keyword.

8. The natural language enterprise system of claim 1, wherein the natural language application server is further configured to:
determine spelling errors in the received command statement; and
correct the spelling errors.

9. The natural language enterprise system of claim 8, wherein the natural language application server is further configured to:
determine if a spelling error is a neologism; and
ignore the spelling error when it is a neologism.

10. The natural language enterprise system of claim 1, wherein the natural language application server is further configured to identify the language used in the command statement.

11. The natural language enterprise system of claim 10, wherein the natural language application server is further configured to identify the at least one keyword using important words in the command statement, where important words are selected from the group consisting of nouns in the command statement and verbs in the command statement.

12. The natural language enterprise system of claim 1, further comprising:
an indexing server configured to communicate with the natural language application server;
wherein the indexing server is configured to:
receive at least one piece of data from at least one enterprise data source; and
generate a natural language index using the at least one piece of data.

13. The natural language enterprise system of claim 12, wherein the indexing server is further configured to:
generate a relationship tree using the at least one piece of data; and
build a vocabulary;
wherein the generated natural language index indexes the generated relationship tree.

14. The natural language enterprise system of claim 13, wherein the indexing server is further configured to build the vocabulary using the at least one piece of data and a vocabulary source selected from the group consisting of a dictionary and a thesaurus.

15. A method for determining natural language commands, comprising:
receiving a command statement using a natural language enterprise system;
parsing the received command statement to identify at least one keyword in the command statement using the natural language enterprise system;
identifying at least one actions to data using a natural language index and the natural language enterprise system, where the natural language index maps keywords to actions to data;
locating at least one piece of enterprise data to which at least one action to data may be performed using the natural language enterprise system; and
initiating at least one action to data that is applied to at least one of the located pieces of enterprise data using the natural language enterprise system.

16. The method of claim 15, wherein at least one located piece of enterprise data is stored using the natural language enterprise system.

17. The method of claim 15, wherein at least one located piece of enterprise data is stored using an enterprise data source separate from the natural language enterprise system.

18. The method of claim 17, further comprising initiating at least one action to data that is applied to at least one of the located pieces of enterprise data by providing a command using the natural language enterprise system to initiate at least one action to data using the enterprise data source.

19. The method of claim 15, wherein at least one piece of enterprise data is identified in the command statement.

20. The method of claim 15, further comprising:
generating a user interface displaying at least one of the determined actions to data using the natural language enterprise system; and
receiving a selection of an action to data via the user interface using the natural language enterprise system, where the selected action to data is selected from the at least one displayed actions to data.

21. The method of claim 15, further comprising generating a list of actions to data using the natural language index and the natural language enterprise system, where the list of actions to data comprises actions to data that are relevant to at least one keyword.

22. The method of claim 15, further comprising:
determining spelling errors in the received command statement using the natural language enterprise system; and
correcting the spelling errors using the natural language enterprise system.

23. The method of claim 22, further comprising:
determining if a spelling error is a neologism using the natural language enterprise system; and
ignoring the spelling error when it is a neologism using the natural language enterprise system.

24. The method of claim 15, further comprising identifying the language used in the command statement using the natural language enterprise system.

25. The method of claim 24, further comprising identifying the at least one keyword using important words in the command statement using the natural language enterprise system, where important words are selected from the group consisting of nouns in the command statement and verbs in the command statement.

26. The method of claim 15, further comprising:
receiving at least one piece of data from at least one enterprise data source using the natural language enterprise system; and
generating a natural language index using the at least one piece of data and the natural language enterprise system.

27. The method of claim 26, further comprising:
generating a relationship tree using the at least one piece of data and the natural language enterprise system, where the generated natural language index indexes the generated relationship tree; and
building a vocabulary using the natural language enterprise system.

28. The method of claim 27, further comprising building the vocabulary using the natural language enterprise system, the at least one piece of data, and a vocabulary source selected from the group consisting of a dictionary and a thesaurus.

29. A natural language enterprise system, comprising:
a database configured to store a natural language index, where the natural language index maps keywords to actions to data;
a natural language application server configured to communicate with the database;
a natural language indexing server configured to communicate with the database; and
a natural language client device configured to communicate with the natural language application server;
wherein the natural language indexing server is configured to:
receive at least one piece of data from at least one enterprise data source;
generate a relationship tree using the at least one piece of data;
build a vocabulary; and
generate a natural language index using the at least one piece of data, where the generated natural language index indexes the generated relationship tree;
wherein the natural language application server is configured to:
receive a command statement from the natural language client device;
parse the received command statement to identify at least one keyword in the command statement;
query the database using at least one keyword to identify at least one actions to data using the natural language index;
transmit at least one of the identified keywords to the natural language client device;
receive at least one action to data from the client device;
locate at least one piece of enterprise data to which at least one of the received actions to data may be performed; and
initiate at least one of the received action to data that is applied to at least one of the located pieces of enterprise data; and
wherein the natural language client device is configured to:
generate a user interface to receive a command statement;
transmit the received command statement to the natural language application server;
receive at least one determined actions to data;
generate a user interface displaying at least one determined action to data;
receive a selection of an action to data via the user interface, where the selected action to data is selected from the at least one displayed actions to data; and
transmit the selected actions to data to the natural language enterprise system.
